(19) United States
(12) Patent Application Publication
(10) Pub. No.: US 2026/0073130 A1
(43) Pub. Date: Mar. 12, 2026

(54) INFORMATION PROCESSING METHOD, INFORMATION PROCESSING DEVICE, AND PROGRAM FOR MANAGING RECIPES

(71) Applicant: Panasonic Intellectual Property Management Co., Ltd., Osaka (JP)

(72) Inventors: Takuya YAMAGUCHI, Osaka (JP); Hiroko IZUMI, Kanagawa (JP); Hiromitsu MORISHITA, Kanagawa (JP); Kenta MURAKAMI, Osaka (JP); Harumi OTSUKA, Hyogo (JP)

(73) Assignee: Panasonic Intellectual Property Management Co., Ltd., Osaka (JP)

(21) Appl. No.: 19/386,145

(22) Filed: Nov. 11, 2025

Related U.S. Application Data
(63) Continuation of application No. PCT/JP2024/015784, filed on Apr. 22, 2024.

(30) Foreign Application Priority Data
May 15, 2023 (JP) 2023-080155

(51) Int. Cl. G06F 40/194; G06Q 30/0207

(52) U.S. Cl. CPC G06F 40/194; G06Q 30/0207

(57) ABSTRACT

A technology for judging the relevance or independence between multiple recipes is to be provided. A management device includes a communication unit, a processing unit, and a storage unit. The communication unit acquires a second recipe for a dish created after a first recipe for a dish. The processing unit calculates a first relevance degree that indicates a degree to which the second recipe contains a first related portion related to the first recipe. The processing unit calculates, based on the first related portion, a second recipe independence degree that indicates a degree to which the second recipe contains a second recipe independent portion independent of the first recipe.

This application is based upon and claims the benefit of priority from the prior Japanese Patent Application No. 2023-080155, filed on May 15, 2023, the entire contents of which are incorporated herein by reference.

### BACKGROUND

### 1. Technical Field

The present disclosure relates to an information processing technology, and particularly to an information processing method, an information processing device, and a program for managing recipes.

### 2. Description of the Related Art

In a service that provides recipes, when recipes created by various users are posted, these recipes are published and distributed on the Internet. In addition, this service also accepts and publishes reports from users who actually cooked based on the recipes (see Patent Literature 1, for example).

### PRIOR ART REFERENCE

### Patent Literature

Patent Literature 1: Japanese Unexamined Patent Application Publication No. 2020-57095

When recipes for multiple dishes are published, recipes for similar dishes may be included. In such a situation, it is desirable to know how much a recipe is independent of other recipes and how much it is related to other recipes.

### SUMMARY

The present disclosure has been made in view of such a situation, and a general purpose thereof is to provide a technology for judging the relevance or independence between multiple recipes.

In response to the above issue, an information processing method according to one embodiment of the present disclosure includes: acquiring a second recipe for a dish created after a first recipe for a dish; calculating a first relevance degree that indicates a degree to which the second recipe contains a first related portion related to the first recipe; and calculating, based on the first related portion, a second recipe independence degree that indicates a degree to which the second recipe contains a second recipe independent portion independent of the first recipe.

Another embodiment of the present disclosure is an information processing device. This device includes: an acquirer that acquires a second recipe for a dish created after a first recipe for a dish; and a processing unit that calculates a first relevance degree that indicates a degree to which the second recipe contains a first related portion related to the first recipe. The processing unit calculates, based on the first related portion, a second recipe independence degree that indicates a degree to which the second recipe contains a second recipe independent portion independent of the first recipe.

Optional combinations of the aforementioned constituting elements, and implementation of the present disclosure in the form of methods, apparatuses, systems, recording media, and computer programs may also be practiced as additional modes of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIGS. 1A-1G illustrate configurations of an appliance control system according to an embodiment;

FIGS. 2A-2E illustrate configurations of functional blocks used in the appliance control system shown in FIGS. 1A-1G;

FIGS. 3A-3H illustrate configurations of functional block sequences used in the appliance control system shown in FIGS. 1A-1G;

FIG. 4 shows an overview of the operation of an appliance shown in FIGS. 1A-1G;

FIG. 5 illustrates a configuration of an information processing system in FIGS. 1A-1G;

FIG. 6 illustrates a configuration of an appliance shown in FIG. 5;

FIG. 7 illustrates a configuration of a user device shown in FIG. 5;

FIG. 8 shows the relationships among multiple recipes created in the information processing system shown in FIG. 5;

FIGS. 9A-9C show elements of recipes stored in the storage unit shown in FIG. 5;

FIG. 10 shows a data structure of a database of recipes stored in the storage unit shown in FIG. 5; and

FIG. 11 is a flowchart that shows the procedure for registration of a new recipe performed by the information processing system shown in FIG. 5.

### DETAILED DESCRIPTION

The invention will now be described by reference to the preferred embodiments. This does not intend to limit the scope of the present invention, but to exemplify the invention.

The embodiment described below shows a suitable specific example of the present disclosure. Therefore, the numerical values, shapes, materials, constituting elements, arranged positions and connection forms of the constituting elements, and the steps (processes) and the order of the steps, for example, described in the following embodiment are mere examples and are not intended to limit the present disclosure. Accordingly, among the constituting elements in the following embodiment, a constituting element that is not described in an independent claim, which indicates the most generic concept of the present disclosure, will be described as an arbitrary constituting element. In each drawing, the same reference characters denote substantially the same configurations, and repetitive description will be omitted or simplified. In the following, the embodiment will be described in the following order: (1) Overview of functional blocks and functional block sequences, (2) Configuration of information processing system, and (3) Management of recipes.

### (1) Overview of Functional Blocks and Functional Block Sequences

In household electrical machinery and equipment such as rice cookers, washing machines, and microwave ovens (hereinafter referred to as “appliances”), the functions and operations of hardware are controlled by software for achieving specific functions. In the present embodiment, an appliance control system is introduced as a mechanism to enable creation or updating of software for controlling an appliance.

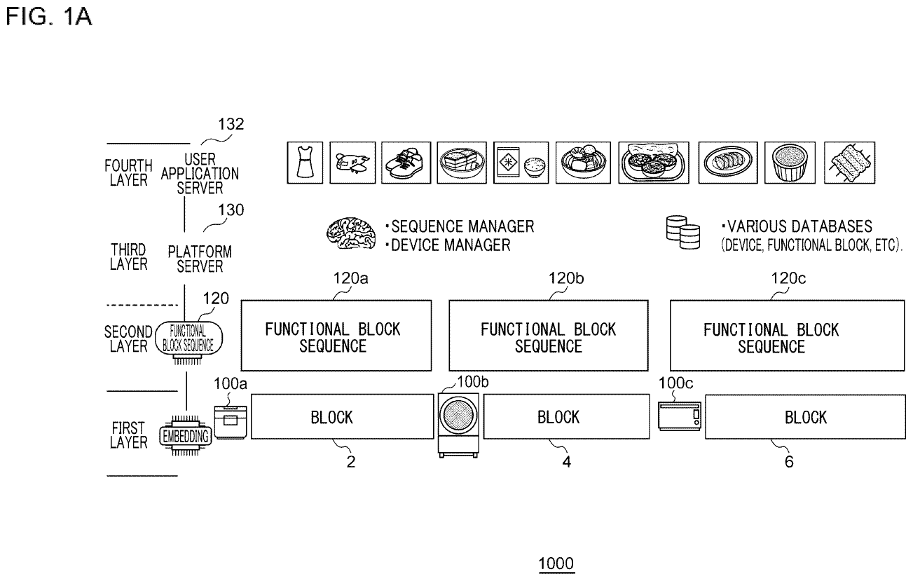

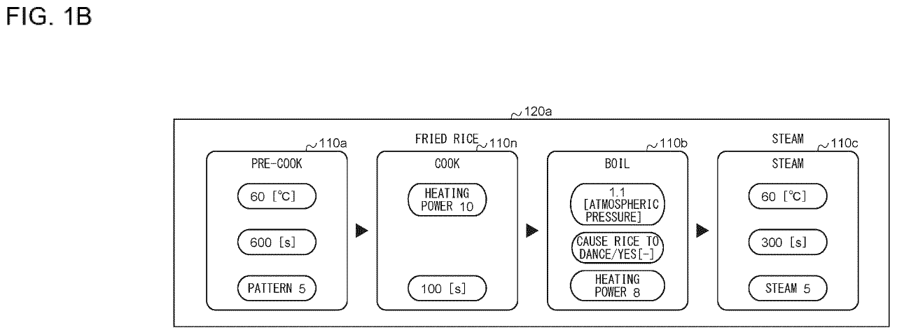

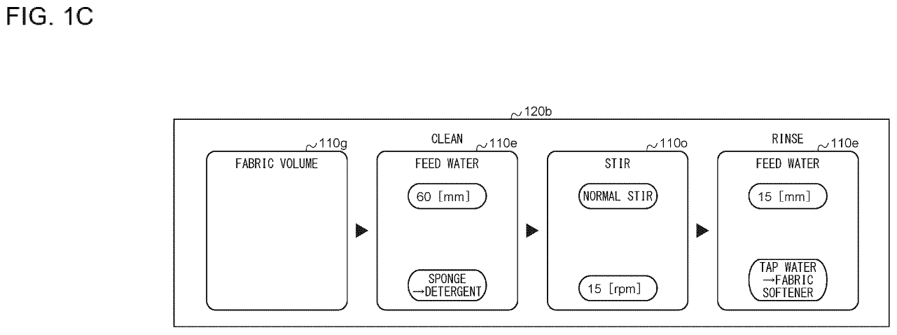

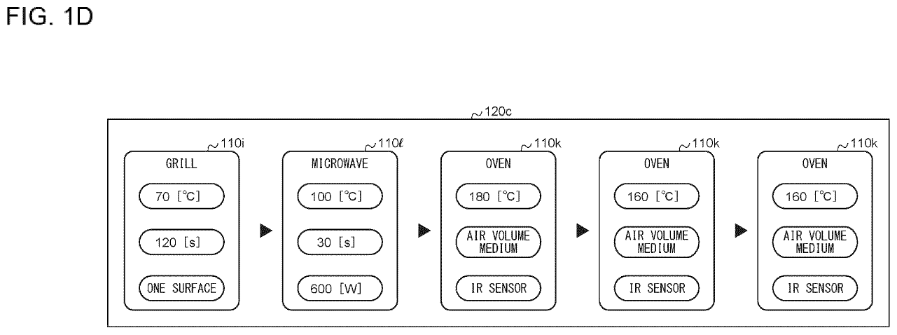

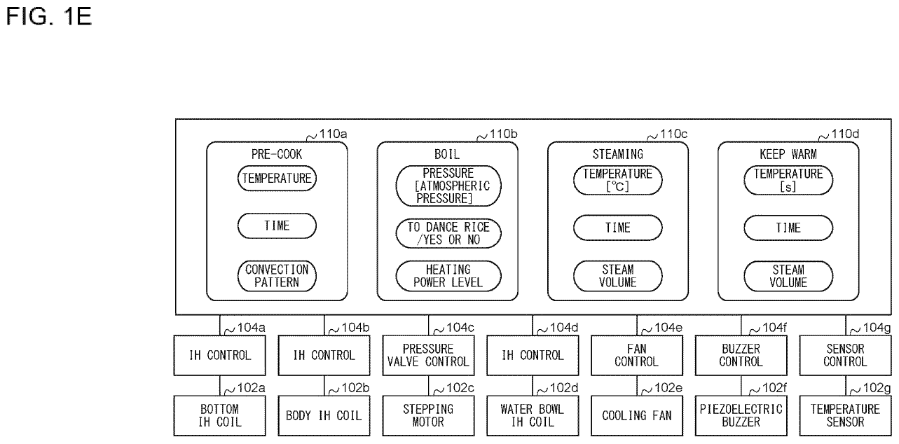

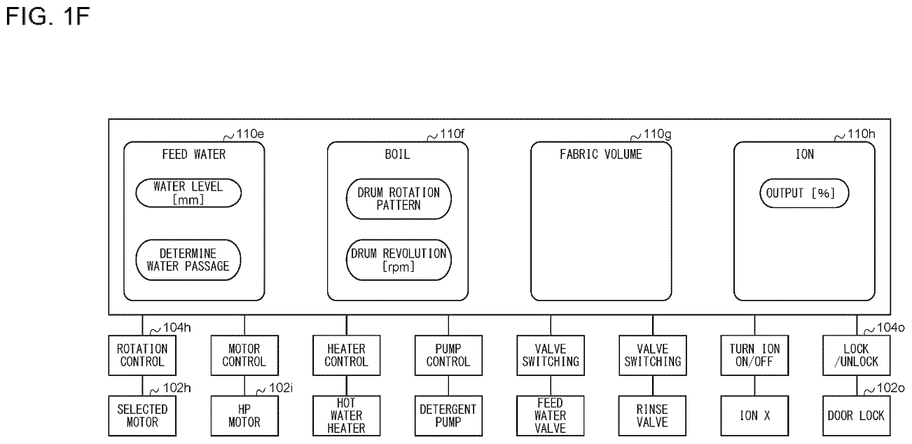

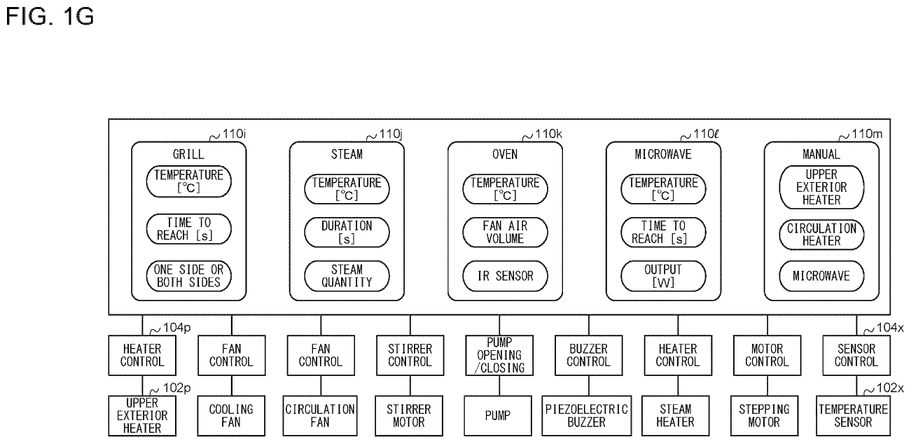

FIGS. 1A-1G illustrate configurations of an appliance control system 1000. In the appliance control system 1000, a four-layer model constituted by the first through fourth layers is defined. In the first layer, the configuration of each appliance 100 is defined. The appliances 100 may be, for example, a rice cooker (an appliance 100a), a washing machine (an appliance 100b), and a microwave oven (an appliance 100c). However, the appliances 100 are not limited thereto. Each appliance 100 includes a block 2 (FIG. 1E), a block 4 (FIG. 1F), or a block 6 (FIG. 1G), and multiple components 102, multiple drivers 104, and multiple functional blocks 110.

The components 102 are hardware elements constituting divided units of operations (actuation and sensing) of an appliance 100 and include actuators and sensors that perform functions of the appliance 100. Actuators are output devices, and sensors are input devices. The actuators include, for example, a bottom induction heating (IH) coil (component 102a), a body IH coil (component 102b), a stepping motor (component 102c), a water bowl IH coil (component 102d), a cooling fan (component 102e), and a piezoelectric buzzer (component 102f) in the rice cooker (appliance 100a). The sensors include, for example, a temperature sensor (component 102g) in the rice cooker (appliance 100a). The components 102 included in the rice cooker (appliance 100a) are not limited thereto, and the washing machine (appliance 100b) and the microwave oven (appliance 100c) are similarly configured.

A driver 104 is software for directly controlling a component 102. In the rice cooker (appliance 100a), IH control (a driver 104) controls the bottom IH coil (component 102a). Also, IH control (a driver 104b) controls the body IH coil (component 102b), pressure valve control (a driver 104c) controls the stepping motor (component 102c), and IH control (a driver 104d) controls the water bowl IH coil (component 102d). Further, fan control (a driver 104e) controls the cooling fan (component 102e), buzzer control (a driver 104f) controls the piezoelectric buzzer (component 102f), and sensor control (a driver 104g) controls the temperature sensor (component 102g). The drivers 104 included in the rice cooker (appliance 100a) are not limited thereto, and the washing machine (appliance 100b) and the microwave oven (appliance 100c) are similarly configured.

A functional block 110 is a software interface (API: Application Programming Interface) associated with one or more drivers 104 to cause one or more components 102 to operate. Each functional block 110 can receive one or more parameters for controlling the operation of a (each) component 102. The functional blocks 110 will be detailed later.

In the second layer, a functional block sequence 120 is defined, in which one or more functional blocks 110 are arranged in order of operation to cause an appliance 100 to perform intended processing. In other words, each functional block sequence 120 defines the order of execution of one or more functional blocks 110. The intended processing is defined for each appliance 100, such as cooking for the rice cooker (appliance 100a) and the microwave oven (appliance 100c), and laundry for the washing machine (appliance 100b). A functional block sequence 120a (FIG. 1B) is used for the rice cooker (appliance 100a), a functional block sequence 120b (FIG. 1C) is used for the washing machine (appliance 100b), and a functional block sequence 120c (FIG. 1D) is used for the microwave oven (appliance 100c). Each appliance 100 executes operations in the order of functional blocks 110 arranged in a functional block sequence 120. Therefore, the functions and operations of an appliance 100 can be updated by changing the arrangement of functional blocks 110 or changing a parameter set in a functional block 110. The functional block sequences 120 will be detailed later.

In the third layer, a platform server 130, which manages various pieces of information in the appliance control system 1000, is located. The platform server 130 includes a sequence manager, a device manager, and various databases. The sequence manager manages the functional block sequences 120, the device manager manages registration information of each appliance 100 in which a functional block sequence 120 can be used, and the various databases manage user information of each user who can use a functional block sequence 120.

In the fourth layer, a user application server 132, which publishes each functional block sequence 120 as a user application, is located. Each functional block sequence 120 published on the user application server 132 is downloaded to an appliance 100. The downloaded functional block sequence 120 is made usable in the appliance 100. When another functional block sequence 120 is downloaded to the appliance 100, the another functional block sequence 120 is made usable in the appliance 100.

The third and fourth layers in the appliance control system 1000 may be integrated. In that case, the platform server 130 and the user application server 132 are integrally configured. Also, the third and fourth layers in the appliance control system 1000 may be arranged in the same layer. Further, the third and fourth layers in the appliance control system 1000 may be omitted. In that case, a functional block sequence 120 is downloaded from a user device (not illustrated) that a user possesses to an appliance 100.

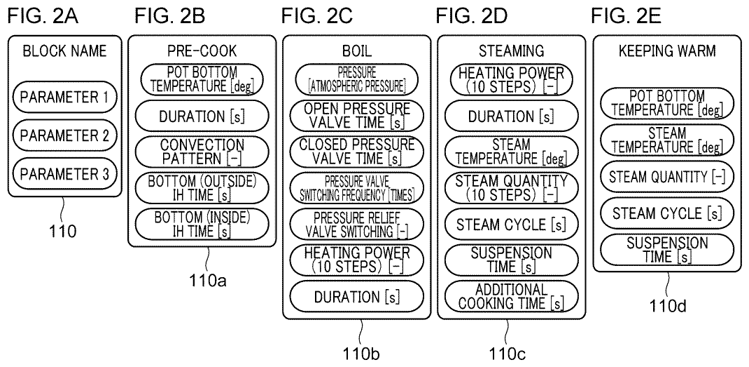

FIGS. 2A-2E illustrate configurations of functional blocks 110 used in the appliance control system 1000. FIG. 2A shows a basic configuration of a functional block 110. The functional blocks 110 are defined in units of functions that can be performed by the appliances 100 and each have a “block name” corresponding to the function. In each functional block 110, multiple parameters associated with the function can be set. Each parameter set in a functional block 110 is output to a driver 104. When receiving a parameter from a functional block 110, the driver 104 controls the operation of a component 102 based on the parameter.

FIG. 2B shows a “pre-cook” functional block 110a in the rice cooker (appliance 100a) shown in FIG. 1A. In the “pre-cook” functional block 110a, the pot bottom temperature, duration, convection pattern, bottom (outside) IH time, and bottom (inside) IH time can be set as parameters. Also, FIG. 2C shows a “boil” functional block 110b in the rice cooker (appliance 100a) shown in FIG. 1A, FIG. 2D shows a “steaming” functional block 110c in the rice cooker (appliance 100a) shown in FIG. 1A, and FIG. 2E shows a “keeping warm” functional block 110d. Multiple parameters can be set also in each of the functional blocks 110b through 110d. The same applies to the functional blocks 110 in the washing machine (appliance 100b) and the microwave oven (appliance 100c) shown in FIG. 1A.

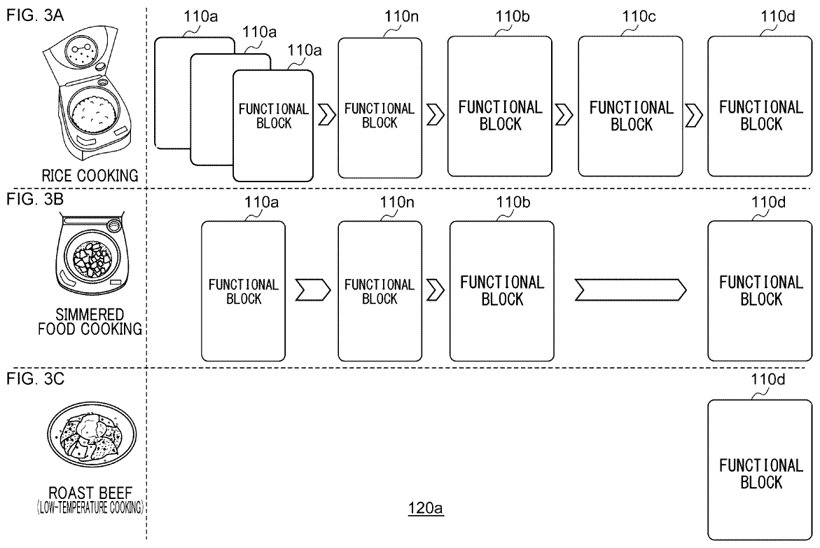

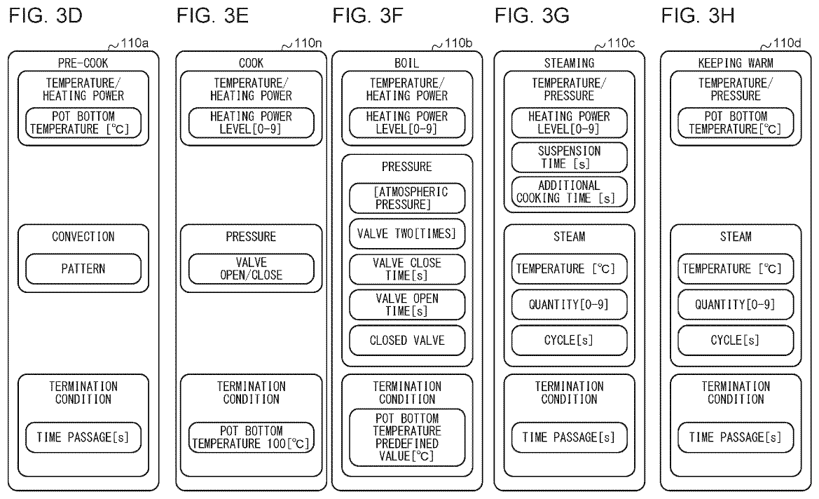

FIGS. 3A-3H illustrate configurations of functional block sequences 120 used in the appliance control system 1000, in particular functional block sequences 120a used in the rice cooker (appliance 100a) shown in FIG. 1A. FIG. 3A shows a sequence for “rice cooking”, FIG. 3B shows a sequence for “simmered food cooking”, and FIG. 3C shows a sequence for “roast beef (low-temperature cooking)”.

In the sequence for “rice cooking” shown in FIG. 3A, three “pre-cook” functional blocks 110a (FIG. 3D), a “cook” functional block 110n (FIG. 3E), a “boil” functional block 110b (FIG. 3F), a “steaming” functional block 110c (FIG. 3G), and a “keeping warm” functional block 110d (FIG. 3H) are arranged in this order. In the three “pre-cook” functional blocks 110a, parameters different from each other are set. Thus, by sequentially arranging the three “pre-cook” functional blocks 110a in which parameters different from each other are set, three-step pre-cooking can be performed.

In the sequence for “simmered food cooking” shown in FIG. 3B, a “pre-cook” functional block 110a, a “cook” functional block 110n, a “boil” functional block 110b, and a “keeping warm” functional block 110d are arranged in this order. In the sequence for “roast beef (low-temperature cooking)” shown in FIG. 3C, a “keeping warm” functional block 110d is included. Thus, by changing the types, arrangement, and parameters of the functional blocks 110 to be used, the processes with different purposes of “rice cooking”, “simmered food cooking”, and “roast beef (low-temperature cooking)” can be performed. The same applies to the functional block sequences 120 for the washing machine (appliance 100b) and the microwave oven (appliance 100c) shown in FIG. 1A.

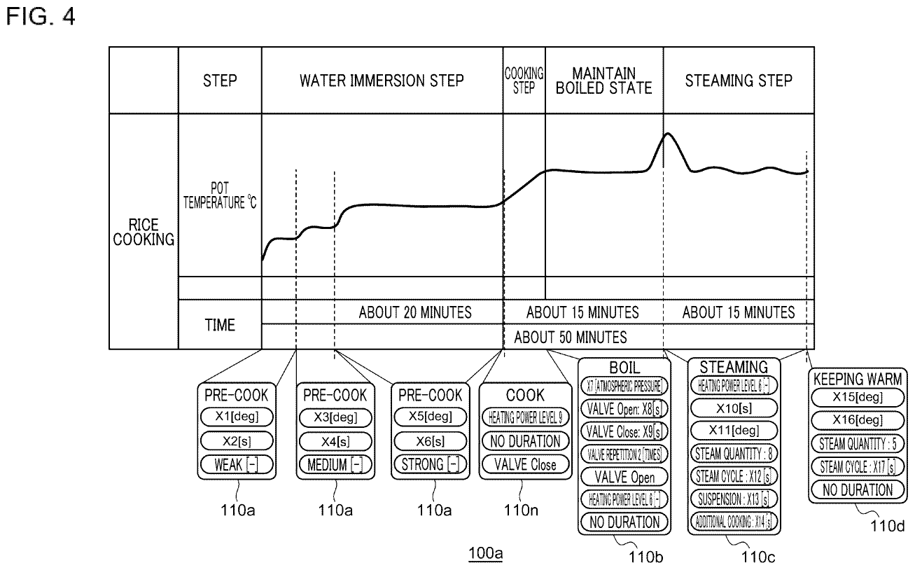

FIG. 4 shows an overview of the operation of an appliance 100, in particular the rice cooker (appliance 100a) shown in FIG. 1A. FIG. 4 shows the operation of the appliance 100a according to the sequence for “rice cooking” in FIG. 3A. In a water immersion step, the three “pre-cook” functional blocks 110a in which parameters different from each other are set are sequentially performed, so that the components 102 corresponding thereto operate based on the parameters. As a result, the pot temperature increases in a stepwise manner over time. Subsequently, the “cook” functional block 110n, the “boil” functional block 110b, the “steaming” functional block 110c, and the “keeping warm” functional block 110d are sequentially performed, so that the components 102 corresponding thereto operate based on the parameters. That is, the multiple functional blocks 110 are sequentially performed, and hence, the rice cooking is performed in the appliance 100a.

In the description given above, functional blocks 110 are defined in units of functions that can be performed by an appliance 100, and a functional block sequence 120 is defined in which one or more functional blocks 110 are arranged in order of operation. Such functional blocks 110 do not include operations to be performed by a person. Meanwhile, actual intended processing may require an operation to be performed by a person. To handle the situation, in the following, the functional blocks 110 and the functional block sequences 120 described above will be extended. Accordingly, the functional blocks 110 will also be defined in units of operations to be performed by a person. With such representation of the functional blocks 110, a person's operations can be treated in the same manner as operations of an appliance 100. Also, functional blocks 110 defined in units of functions that can be performed by an appliance 100 are defined as “first-type blocks”, and functional blocks 110 defined in units of operations to be performed by a person are defined as “second-type blocks”. In the following, the functional blocks 110 will be used without distinguishing between the first-type blocks and the second-type blocks.

### (2) Configuration of Information Processing System

A documented procedure that shows a procedure for cooking a dish is generally called a “recipe”. In a recipe, processes such as “baking” and “steaming” are sequentially arranged. Such a recipe is often provided as a document describing how to cook a dish. Meanwhile, in a functional block sequence 120 used to cook a dish, one or more functional blocks 110 are arranged in order of operation, as described previously. Thus, a functional block sequence 120 and functional blocks 110 have roles similar to a recipe and processes. In the following, a functional block sequence 120 is treated as one form of a recipe. That is, a recipe includes a document describing how to cook a dish, and a functional block sequence 120.

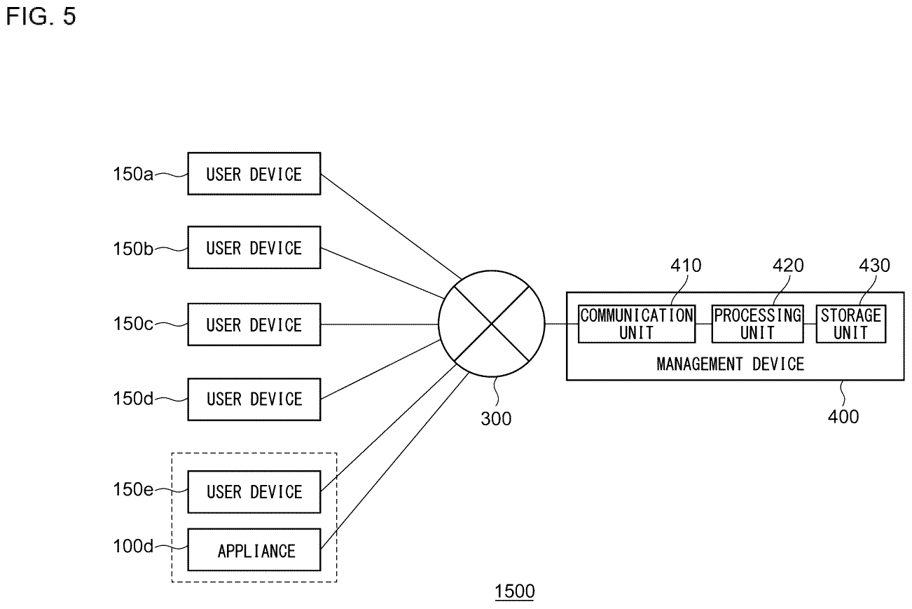

FIG. 5 shows a configuration of an information processing system 1500. The information processing system 1500 includes an appliance 100d, a user device 150a, a user device 150b, a user device 150c, a user device 150d, a user device 150e, a network 300, and a management device 400. The management device 400 includes a communication unit 410, a processing unit 420, and a storage unit 430. The number of appliances 100 (the appliance 100d) included in the information processing system 1500 is not limited to “1”. Also, the number of user devices 150 (the user devices 150a through 150e) included in the information processing system 1500 is not limited to “5”. Further, the management device 400 may be constituted by two or more devices.

The management device 400 corresponds to the platform server 130 and the user application server 132 shown in FIG. 1A. Therefore, the appliance 100d and the management device 400 in the information processing system 1500 correspond to the appliance control system 1000 of FIG. 1A.

The appliance 100d is a cooking appliance, such as a rice cooker, a microwave oven, or an IH cooking heater. The appliance 100d performs processes of the first layer and the second layer in FIGS. 1A and 1s connected to the network 300. Besides the appliance 100d, the user devices 150a through 150e (user devices 150) and the management device 400 are also connected to the network 300. In the network 300, one of wired communication, wireless communication, or a combination of wired communication and wireless communication is performed between these devices.

Each user device 150 is a device used by a user who performs intended processing, such as cooking, and may be a computer, a smartphone, or a tablet terminal, for example. Here, as an example, the user device 150a is used by a user A, the user device 150b is used by a user B, the user device 150c is used by a user C, and the user device 150d is used by a user D. Also, the user device 150e and the appliance 100d are used by a user E.

The user A creates a recipe using the user device 150a. The user device 150a transmits the recipe to the management device 400 via the network 300. The management device 400 may be, for example, a computer such as a server or a cloud server equipped with a processor, memory, and the like. Upon receiving a recipe from a user device 150, the management device 400 judges whether the recipe can be registered (stored). When the recipe can be registered, the management device 400 starts managing (storing) the recipe. The management device 400 performs the same processing also when the user B creates a recipe using the user device 150b, when the user C creates a recipe using the user device 150c, or when the user D creates a recipe using the user device 150d.

The user device 150e receives, from the user E, information (a purchase request) regarding a recipe of a dish to be cooked with the appliance 100d. The user device 150e transmits the information regarding the recipe to the management device 400 via the network 300. Upon receiving the information regarding the recipe from the user device 150e, the management device 400 selects a functional block sequence 120 corresponding to the recipe included in the information and transmits information on the functional block sequence 120 to the appliance 100d via the network 300. Upon receiving the information on the functional block sequence 120 from the management device 400, the appliance 100d performs operation according to the functional block sequence 120.

Multiple recipes may include a recipe (hereinafter referred to as a “derived recipe”) derived from another recipe (hereinafter referred to as a “deriving source recipe”). When a derived recipe is purchased, a reward for the derived recipe can be obtained. Since the derived recipe is based on the deriving source recipe, the reward should be appropriately distributed not only to the creator of the derived recipe, but also to the creator of the deriving source recipe. However, since the degree to which a derived recipe utilizes a deriving source recipe varies for each derived recipe, the reward distributed to the creator of a deriving source recipe should be varied based on the degree of utilization of the deriving source recipe. In order to perform such processing, it is necessary to judge in advance how similar the recipes are to each other (relevance) and how dissimilar they are to each other (independence). The management device 400 in the present embodiment judges the relevance or independence between multiple recipes through processing described later.

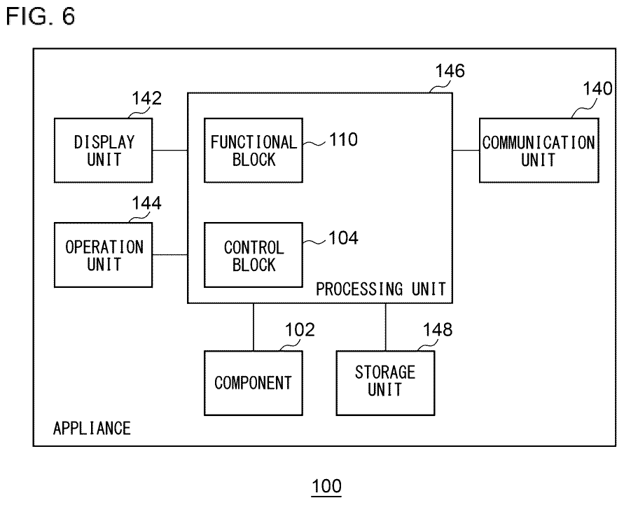

FIG. 6 shows a configuration of an appliance 100. The appliance 100 includes a component 102, a communication unit 140, a display unit 142, an operation unit 144, a processing unit 146, and a storage unit 148. The processing unit 146 includes a functional block 110 and a driver 104. As described previously, the appliance 100 is household electrical machinery and equipment for cooking, such as a rice cooker, a microwave oven, or an IH cooking heater. Although multiple components 102, multiple drivers 104, and multiple functional blocks 110 are provided as shown in FIGS. 1B-1G, only one of each is shown here for clarity of the drawing.

The communication unit 140 is connected to the network 300 and performs communication with the management device 400 via the network 300. For example, the communication unit 140 receives information on a functional block sequence 120 from the management device 400. This functional block sequence 120 includes a functional block 110 to be executed by the appliance 100, among the functional block sequences 120 for the intended processing. The storage unit 148 stores functional blocks 110 that can be executed by the appliance 100. The processing unit 146 reads a functional block 110 stored in the storage unit 148 based on the information on the functional block sequence 120 received at the communication unit 140 and allows a component 102, via a driver 104, to perform processing according to the functional block sequence 120. After performing the processing according to the functional block sequence 120, the processing unit 146 generates a notification indicating that the execution of the recipe has been completed (hereinafter referred to as the “recipe execution notification”), and the communication unit 140 may transmit the recipe execution notification to the management device 400.

The display unit 142 displays information from the processing unit 146. The operation unit 144 is an interface capable of receiving input from a user and may be a button, for example. The display unit 142 and the operation unit 144 may be integrated as a touch panel. The operation unit 144 then outputs the received input to the processing unit 146.

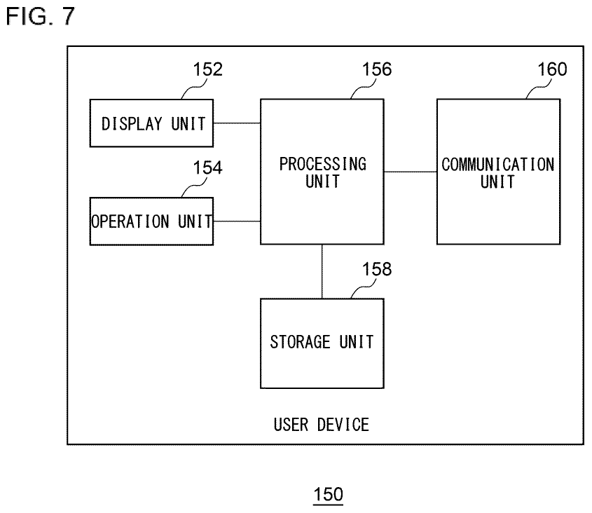

FIG. 7 shows a configuration of a user device 150. The user device 150 includes a display unit 152, an operation unit 154, a processing unit 156, a storage unit 158, and a communication unit 160. As described previously, the user device 150 may be a computer, a smartphone, or a tablet terminal. The display unit 152 displays information received from the processing unit 156. The operation unit 154 is an interface capable of receiving input from a user and may be a button, for example. The display unit 152 and the operation unit 154 may be integrated as a touch panel. The operation unit 154 then outputs the received input to the processing unit 156.

The processing unit 156 outputs information to be displayed to the display unit 152 and receives input from the operation unit 154. The processing unit 156 also stores information in the storage unit 158 and reads information from the storage unit 158. Further, the processing unit 156 connects to the network 300 via the communication unit 160 and performs communication with the management device 400 via the network 300. With such a configuration, when the operation unit 154 receives predetermined information from a user, the processing unit 156 allows the communication unit 160 to transmit the predetermined information to the management device 400.

### (3) Management of Recipes

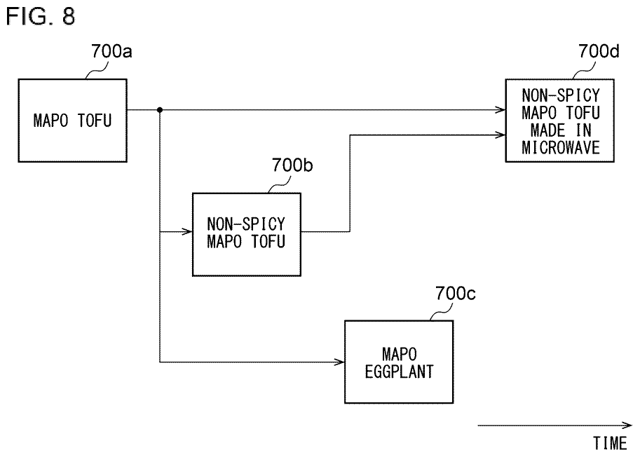

In the interest of clarity, it is assumed here that multiple recipes are created as shown in FIG. 8. FIG. 8 shows the relationships among multiple recipes 700 created in the information processing system 1500. The direction from the left side to the right side in FIG. 8 indicates the direction in which time progresses. Therefore, the recipes 700 for multiple dishes are created in the order of a recipe 700a for “Mapo tofu”, a recipe 700b for “Non-spicy Mapo tofu”, a recipe 700c for “Mapo eggplant”, and a recipe 700d for “Non-spicy Mapo tofu made in microwave”. Here, the recipe 700a for “Mapo tofu”, the recipe 700b for “Non-spicy Mapo tofu”, the recipe 700c for “Mapo eggplant”, and the recipe 700d for “Non-spicy Mapo tofu made in microwave” may be respectively referred to as a first recipe, a second recipe, a third recipe, and a fourth recipe.

Also, each arrow shown in FIG. 8 indicates derivation. Accordingly, when the recipe 700a for “Mapo tofu” is the deriving source recipe, the recipe 700b for “Non-spicy Mapo tofu” is a derived recipe. Also, when the recipe 700a for “Mapo tofu” is the deriving source recipe, the recipe 700c for “Mapo eggplant” is also a derived recipe. Further, when the recipe 700a for “Mapo tofu” and the recipe 700b for “Non-spicy Mapo tofu” are the deriving source recipes, the recipe 700d for “Non-spicy Mapo tofu made in microwave” is a derived recipe.

In order to judge the derived recipes or to calculate rewards, the following terms are defined. When it is assumed that there are a recipe A and a recipe B (the recipe A was created before the recipe B in time), an index indicating how much the recipe B uses the recipe A is defined as the relevance degree of the recipe A to the recipe B. The relevance degree can also be regarded as an index indicating the degree to which the recipe B contains a portion related to the recipe A. Also, an index indicating uniqueness of the recipe B that does not belong to any recipes created prior to the recipe B is defined as the independence degree of the recipe B. The independence degree can also be regarded as an index indicating the degree to which the recipe B contains a recipe independent portion that is independent of any recipes created prior to the recipe B. The relevance degree is calculated for every recipe created prior to the recipe being processed. When the relevance degree is calculated, only the unique portion of each recipe created prior to the recipe being processed is considered.

In the following, (i) Processing for recipe 700a for “Mapo tofu”, (ii) Processing for recipe 700b for “Non-spicy Mapo tofu”, (iii) Processing for recipe 700c for “Mapo eggplant”, and (iv) Processing for recipe 700d for “Non-spicy Mapo tofu made in microwave” will be described in this order.

### (i) Processing for Recipe 700a for “Mapo Tofu”

When the operation unit 154 of the user device 150a receives a corresponding operation by the user A, the processing unit 156 creates the recipe 700a for “Mapo tofu”. The recipe 700a for “Mapo tofu” is created by arranging multiple functional blocks 110 and setting a parameter in each functional block 110, for example. The processing unit 156 generates a signal (hereinafter referred to as a “registration request”) for requesting registration of the recipe 700a for “Mapo tofu”, and the communication unit 160 transmits the registration request. The registration request includes the recipe 700a for “Mapo tofu”, the name of the recipe 700a for “Mapo tofu”, the date and time of creation of the recipe 700a for “Mapo tofu”, identification information (hereinafter referred to as a “user ID”) of the user A, and information (hereinafter referred to as “reward receipt”) indicating whether to receive (True) or not to receive (False) a reward for the recipe 700a for “Mapo tofu”.

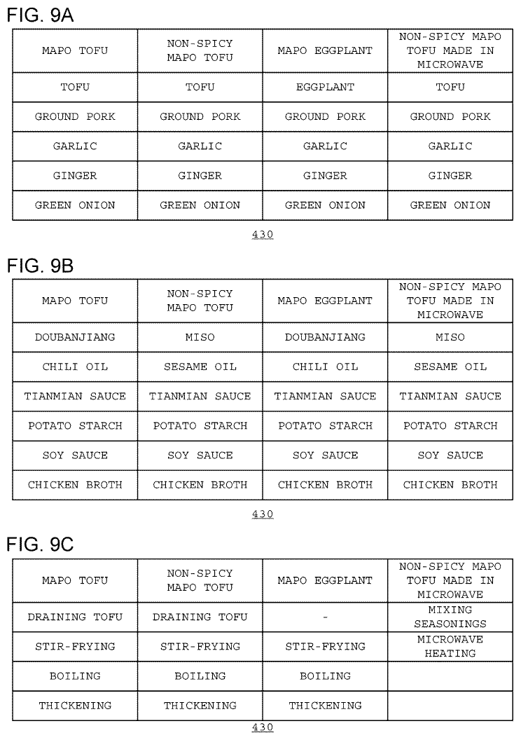

The communication unit 410 of the management device 400 receives the registration request. Accordingly, the communication unit 410 obtains the recipe 700a for “Mapo tofu”. The processing unit 420 stores the recipe 700a for “Mapo tofu” in the storage unit 430. FIGS. 9A-9C show elements of recipes 700 stored in the storage unit 430. Each recipe 700 includes ingredient information, seasoning information, and order information, and each of the ingredient information, seasoning information, and order information includes one or more elements. FIG. 9A shows elements included in the ingredient information, FIG. 9B shows elements included in the seasoning information, and FIG. 9C shows elements included in the order information.

As shown in FIG. 9A, the elements included in the ingredient information of the recipe 700a for “Mapo tofu” are tofu, ground pork, garlic, ginger, and green onion. As shown in FIG. 9B, the elements included in the seasoning information of the recipe 700a for “Mapo tofu” are doubanjiang (broad bean paste), chili oil, tianmian sauce (sweet flour sauce), potato starch, soy sauce, and chicken broth. As shown in FIG. 9C, the elements included in the order information of the recipe 700a for “Mapo tofu” are draining tofu, stir-frying, boiling, and thickening, arranged in this order. It is assumed that information on the elements other than the elements of the recipe 700a for “Mapo tofu” in FIGS. 9A-9C is not stored in the storage unit 430 at the time. The description will now return to FIG. 5.

The processing unit 420 judges whether or not the recipe 700a for “Mapo tofu” can be registered. Although details of the judgment will be described later, since the information on the elements other than those of the recipe 700a for “Mapo tofu” is not stored in the storage unit 430, the processing unit 420 determines the registration of the recipe 700a for “Mapo tofu”. Upon determining the registration of the recipe 700a for “Mapo tofu”, the processing unit 420 leaves the information on the elements of the recipe 700a for “Mapo tofu” stored in the storage unit 430 as it is. Also, the processing unit 420 adds information regarding the recipe 700a for “Mapo tofu” to a database in the storage unit 430. On the other hand, when it is determined that the recipe 700a for “Mapo tofu” will not be registered, the processing unit 420 deletes the information on the elements of the recipe 700a for “Mapo tofu” stored in the storage unit 430.

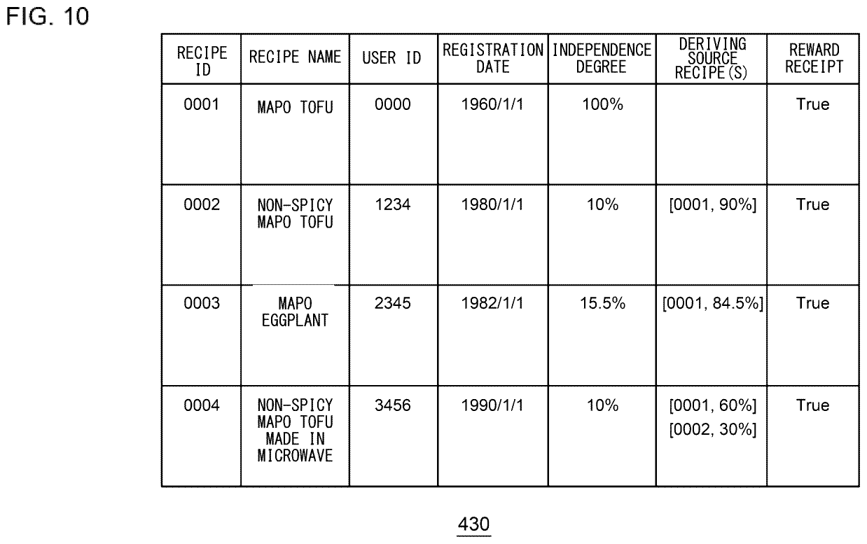

FIG. 10 shows a data structure of the database of recipes 700 stored in the storage unit 430. The database includes a recipe ID for identifying a recipe 700, a recipe name as the name of the recipe 700, the user ID, the registration date, the independence degree, the deriving source recipe(s), and the reward receipt. In this example, as the information regarding the recipe 700a for “Mapo tofu”, information identified by a recipe ID “0001” is stored. Since the recipe 700a for “Mapo tofu” is independent of the recipes 700 created prior to the recipe 700a for “Mapo tofu”, the independence degree is set to “100%”, and the deriving source recipe(s) field is left blank. It is assumed that no information other than that regarding the recipe ID “0001” is stored in the database.

When a reward for the recipe 700a for “Mapo tofu” is obtained, the processing unit 420 recognizes that the independence degree of the recipe 700a for “Mapo tofu” is 100% according to FIG. 10 and determines that the entire reward will be paid to the user A, who is the creator of the recipe 700a for “Mapo tofu”.

### (ii) Processing for Recipe 700b for “Non-Spicy Mapo Tofu”

When the operation unit 154 of the user device 150b receives a corresponding operation by the user B, the processing unit 156 creates the recipe 700b for “Non-spicy Mapo tofu”. The recipe 700b for “Non-spicy Mapo tofu” is created in the same manner as the recipe 700a for “Mapo tofu”. The processing unit 156 generates a registration request for requesting registration of the recipe 700b for “Non-spicy Mapo tofu”, and the communication unit 160 transmits the registration request.

The communication unit 410 of the management device 400 receives the registration request. Accordingly, the communication unit 410 obtains the recipe 700b for “Non-spicy Mapo tofu”. The processing unit 420 stores the recipe 700b for “Non-spicy Mapo tofu” in the storage unit 430. As shown in FIG. 9A, the elements included in the ingredient information of the recipe 700b for “Non-spicy Mapo tofu” are tofu, ground pork, garlic, ginger, and green onion. As shown in FIG. 9B, the elements included in the seasoning information of the recipe 700b for “Non-spicy Mapo tofu” are miso, sesame oil, tianmian sauce (sweet flour sauce), potato starch, soy sauce, and chicken broth. As shown in FIG. 9C, the elements included in the order information of the recipe 700b for “Non-spicy Mapo tofu” are draining tofu, stir-frying, boiling, and thickening, arranged in this order. The description will now return to FIG. 5.

The processing unit 420 judges whether or not the recipe 700b for “Non-spicy Mapo tofu” can be registered. The processing unit 420 checks the database shown in FIG. 10 and identifies the recipe 700a for “Mapo tofu” registered prior to the date and time of creation of the recipe 700b for “Non-spicy Mapo tofu”. The processing unit 420 then calculates the relevance degree (hereinafter referred to as the “first relevance degree”) that indicates the degree to which the subject recipe contains a portion (hereinafter referred to as a “first related portion”) related to a recipe 700 already stored in the storage unit 430, such as the recipe 700a for “Mapo tofu”.

The calculation of the first relevance degree may be performed as follows, for example. The processing unit 420 identifies elements that are identical between the ingredient information of the recipe 700b for “Non-spicy Mapo tofu” and the ingredient information of the recipe 700a for “Mapo tofu”. The processing unit 420 then calculates the ratio of the number of identical elements to the number of elements in the ingredient information of the recipe 700a for “Mapo tofu”, as the relevance degree in the ingredient information. According to FIG. 9A, since these five elements are all identical elements, the relevance degree in the ingredient information is “1”.

The processing unit 420 also identifies elements that are identical between the seasoning information of the recipe 700b for “Non-spicy Mapo tofu” and the seasoning information of the recipe 700a for “Mapo tofu”. The processing unit 420 then calculates the ratio of the number of identical elements to the number of elements in the seasoning information of the recipe 700a for “Mapo tofu”, as the relevance degree in the seasoning information. According to FIG. 9B, since four of the six elements in the seasoning information of the recipe 700a for “Mapo tofu” are identical elements, the relevance degree in the seasoning information is “4/6”.

Further, the processing unit 420 identifies elements that are identical between the order information of the recipe 700b for “Non-spicy Mapo tofu” and the order information of the recipe 700a for “Mapo tofu”. The processing unit 420 then calculates the ratio of the number of identical elements to the number of elements in the order information of the recipe 700a for “Mapo tofu”, as the relevance degree in the order information. According to FIG. 9C, since these four elements are all identical elements, the relevance degree in the order information is “1”. Among the elements of the recipe 700b for “Non-spicy Mapo tofu”, elements identical with elements in the recipe 700a for “Mapo tofu” correspond to the first related portion described previously.

Also, the processing unit 420 predetermines an allocation rate of the ingredient information, an allocation rate of the seasoning information, and an allocation rate of the order information. For example, the allocation rate of the ingredient information is set to “40%”, the allocation rate of the seasoning information is set to “30%”, and the allocation rate of the order information is set to “30%”. These allocation rates are not limited to the above values, as long as the sum of these allocation rates is “100%”. The processing unit 420 calculates the relevance degree (first relevance degree) as follows.

Relevance degree=Allocation rate of ingredient information×Relevance degree in ingredient information+Allocation rate of seasoning information×Relevance degree in seasoning information+Allocation rate of order information×Relevance degree in order information Formula(1)

By substituting the aforementioned values into Formula (1), the processing unit 420 calculates the first relevance degree as “90%”.

Based on a related portion, such as the first related portion, the processing unit 420 calculates the independence degree (hereinafter referred to as the “second recipe independence degree”) that indicates the degree to which the recipe 700b for “Non-spicy Mapo tofu” contains a portion (hereinafter referred to as a “second recipe independent portion”) independent of a recipe 700 already stored in the storage unit 430, such as the recipe 700a for “Mapo tofu”. The second recipe independence degree is calculated, for example, by subtracting the first relevance degree from 100%. In this example, the second recipe independence degree is “10%”.

When the second recipe independence degree is greater than or equal to a threshold, the processing unit 420 determines the registration of the recipe 700b for “Non-spicy Mapo tofu”. The threshold may be set to “5%”, for example, but is not limited thereto. Upon determining the registration of the recipe 700b for “Non-spicy Mapo tofu”, the processing unit 420 leaves the information on the elements of the recipe 700b for “Non-spicy Mapo tofu” stored in the storage unit 430 as it is. Also, the processing unit 420 adds information regarding the recipe 700b for “Non-spicy Mapo tofu” to the database in the storage unit 430. On the other hand, when it is determined that the recipe 700b for “Non-spicy Mapo tofu” will not be registered, the processing unit 420 deletes the information on the elements of the recipe 700b for “Non-spicy Mapo tofu” stored in the storage unit 430.

In the database shown in FIG. 10, information identified by a recipe ID “0002” is stored as the information regarding the recipe 700b for “Non-spicy Mapo tofu”. As the independence degree of the recipe 700b for “Non-spicy Mapo tofu”, the second recipe independence degree of “10%” is input. Also, as the deriving source recipe of the recipe 700b for “Non-spicy Mapo tofu”, the first relevance degree of the recipe ID “0001”, i.e., “90%”, is input. The description will now return to FIG. 5.

When a reward (hereinafter referred to as the “overall reward”) for the recipe 700b for “Non-spicy Mapo tofu” is obtained, the processing unit 420 acquires, from the database shown in FIG. 10, the second recipe independence degree of “10%” and the relevance degree of the recipe ID “0001”, i.e., the first relevance degree, of “90%”. The partial reward for the user B, who is the creator of the recipe 700b for “Non-spicy Mapo tofu”, is shown as follows.

Partial reward for user B=Overall reward×Second recipe independence degree Formula (2)

That is, the processing unit 420 determines the partial reward for the user B based on the second recipe independence degree, with respect to the overall reward for the recipe 700b for “Non-spicy Mapo tofu”. In the case of the database shown in FIG. 10, the partial reward for the user B is 10% of the overall reward. Formula (2) can be generalized as follows.

Partial reward for creator of recipe=Overall reward×Independence degree Formula (3)

Also, when the overall reward for the recipe 700b for “Non-spicy Mapo tofu” is obtained, the processing unit 420 calculates the partial reward for the user A, who is the creator of the deriving source recipe, as follows.

Partial reward for user A=Overall reward×(1−Second recipe independence degree)=Overall reward×First relevance degree Formula (4)

That is, the processing unit 420 determines the partial reward for the user A based on the first relevance degree, with respect to the overall reward for the recipe 700b for “Non-spicy Mapo tofu”. In the case of FIG. 10, the partial reward for the user A is 90% of the overall reward.
(iii) Processing for Recipe 700c for “Mapo Eggplant”

When the operation unit 154 of the user device 150c receives a corresponding operation by the user C, the processing unit 156 creates the recipe 700c for “Mapo eggplant”. The recipe 700c for “Mapo eggplant” is created in the same manner as the recipe 700a for “Mapo tofu”. The processing unit 156 generates a registration request for requesting registration of the recipe 700c for “Mapo eggplant”, and the communication unit 160 transmits the registration request.

The communication unit 410 of the management device 400 receives the registration request. Accordingly, the communication unit 410 obtains the recipe 700c for “Mapo eggplant”. The processing unit 420 then stores the recipe 700c for “Mapo eggplant” in the storage unit 430. As shown in FIG. 9A, the elements included in the ingredient information of the recipe 700c for “Mapo eggplant” are eggplant, ground pork, garlic, ginger, and green onion. As shown in FIG. 9B, the elements included in the seasoning information of the recipe 700c for “Mapo eggplant” are doubanjiang (broad bean paste), chili oil, tianmian sauce (sweet flour sauce), potato starch, soy sauce, and chicken broth. As shown in FIG. 9C, the elements included in the order information of the recipe 700c for “Mapo eggplant” are stir-frying, boiling, and thickening, arranged in this order. The description will now return to FIG. 5.

The processing unit 420 judges whether or not the recipe 700c for “Mapo eggplant” can be registered. The processing unit 420 checks the database shown in FIG. 10 and identifies the recipe 700a for “Mapo tofu” and the recipe 700b for “Non-spicy Mapo tofu” registered prior to the date and time of creation of the recipe 700c for “Mapo eggplant”. The processing unit 420 then calculates the relevance degree (hereinafter referred to as the “second relevance degree”) that indicates the degree to which the recipe 700c for “Mapo eggplant” contains a portion (hereinafter referred to as a “second related portion”) related to a recipe 700 already stored in the storage unit 430, such as the recipe 700a for “Mapo tofu”.

The calculation of the second relevance degree may be performed as follows, for example. The processing unit 420 identifies elements that are identical between the ingredient information of the recipe 700c for “Mapo eggplant” and the ingredient information of the recipe 700a for “Mapo tofu”. The processing unit 420 then calculates the ratio of the number of identical elements to the number of elements in the ingredient information of the recipe 700a for “Mapo tofu”, as the relevance degree in the ingredient information. According to FIG. 9A, since four of the five elements in the ingredient information of the recipe 700a for “Mapo tofu” are identical elements, the relevance degree in the ingredient information is “4/5”.

The processing unit 420 also identifies elements that are identical between the seasoning information of the recipe 700c for “Mapo eggplant” and the seasoning information of the recipe 700a for “Mapo tofu”. The processing unit 420 then calculates the ratio of the number of identical elements to the number of elements in the seasoning information of the recipe 700a for “Mapo tofu”, as the relevance degree in the seasoning information. According to FIG. 9B, since these six elements are all identical elements, the relevance degree in the seasoning information is “1”.

Further, the processing unit 420 identifies elements that are identical between the order information of the recipe 700c for “Mapo eggplant” and the order information of the recipe 700a for “Mapo tofu”. The processing unit 420 then calculates the ratio of the number of identical elements to the number of elements in the order information of the recipe 700a for “Mapo tofu”, as the relevance degree in the order information. According to FIG. 9C, since three of the four elements in the order information of the recipe 700a for “Mapo tofu” are identical elements, the relevance degree in the ingredient information is “3/4”. Among the elements of the recipe 700c for “Mapo eggplant”, elements identical with elements in the recipe 700a for “Mapo tofu” correspond to the second related portion described previously. By substituting the aforementioned values into Formula (1), the processing unit 420 calculates the second relevance degree as “84.5%”.

Subsequently, the processing unit 420 calculates the relevance degree (hereinafter referred to as the “third relevance degree”) that indicates the degree to which the recipe 700c for “Mapo eggplant” contains a portion (hereinafter referred to as a “third related portion”) related to a recipe 700 already stored in the storage unit 430, such as the second recipe independent portion. As described previously, the second recipe independent portion indicates elements among the elements of the recipe 700b for “Non-spicy Mapo tofu” that are not identical with elements in the recipe 700a for “Mapo tofu”.

The calculation of the third relevance degree may be performed as follows, for example. The processing unit 420 identifies elements that are identical between the ingredient information of the recipe 700c for “Mapo eggplant” and the ingredient information of the second recipe independent portion. Since there is no ingredient information in the second recipe independent portion, the relevance degree in the ingredient information is “0”.

The processing unit 420 also identifies elements that are identical between the seasoning information of the recipe 700c for “Mapo eggplant” and the seasoning information of the second recipe independent portion. The processing unit 420 then calculates the ratio of the number of identical elements to the number of elements in the seasoning information of the second recipe, as the relevance degree in the seasoning information. According to FIG. 9B, since all of the two elements in the seasoning information of the second recipe independent portion are not identical elements, the relevance degree in the seasoning information is “0”.

Further, the processing unit 420 identifies elements that are identical between the order information of the recipe 700c for “Mapo eggplant” and the order information of the second recipe independent portion. Since there is no order information in the second recipe independent portion, the relevance degree in the order information is “0”. Among the elements of the recipe 700c for “Mapo eggplant”, an element identical with an element in the second recipe independent portion corresponds to the third related portion described previously. However, there is no third related portion, and, by substituting the aforementioned values into Formula (1), the processing unit 420 calculates the third relevance degree as “0%”. Therefore, it can be said that the recipe 700c for “Mapo eggplant” is not derived from the recipe 700b for “Non-spicy Mapo tofu”.

Based on a related portion, such as the second related portion and the third related portion, the processing unit 420 calculates the independence degree (hereinafter referred to as the “third recipe independence degree”) that indicates the degree to which the recipe 700c for “Mapo eggplant” contains a portion (hereinafter referred to as a “third recipe independent portion”) independent of a recipe 700 already stored in the storage unit 430, such as the recipe 700a for “Mapo tofu” and the recipe 700b for “Non-spicy Mapo tofu”. The third recipe independence degree is calculated, for example, by subtracting the second relevance degree and the third relevance degree from 100%. In this example, the third recipe independence degree is “15.5%”.

When the third recipe independence degree is greater than or equal to a threshold, the processing unit 420 determines the registration of the recipe 700c for “Mapo eggplant”. Upon determining the registration of the recipe 700c for “Mapo eggplant”, the processing unit 420 leaves the information on the elements of the recipe 700c for “Mapo eggplant” stored in the storage unit 430 as it is. Also, the processing unit 420 adds information regarding the recipe 700c for “Mapo eggplant” to the database in the storage unit 430. On the other hand, when it is determined that the recipe 700c for “Mapo eggplant” will not be registered, the processing unit 420 deletes the information on the elements of the recipe 700c for “Mapo eggplant” stored in the storage unit 430.

In the database shown in FIG. 10, information identified by a recipe ID “0003” is stored as the information regarding the recipe 700c for “Mapo eggplant”. As the independence degree of the recipe 700c for “Mapo eggplant”, the third recipe independence degree of “15.5%” is input. Also, as the deriving source recipe of the recipe 700c for “Mapo eggplant”, the second relevance degree of the recipe ID “0001”, i.e., “84.5%”, is input. The description will now return to FIG. 5.

When the overall reward for the recipe 700c for “Mapo eggplant” is obtained, the processing unit 420 acquires, from the database shown in FIG. 10, the third recipe independence degree of “15.5%” and the relevance degree of the recipe ID “0001”, i.e., the second relevance degree, of “84.5%”. The partial reward for the user C, who is the creator of the recipe 700c for “Mapo eggplant”, is 15.5% of the overall reward, according to Formula (3). That is, the processing unit 420 determines the partial reward for the user C based on the third recipe independence degree, with respect to the overall reward for the recipe 700c for “Mapo eggplant”.

Also, when the overall reward for the recipe 700c for “Mapo eggplant” is obtained, the processing unit 420 calculates the partial reward for the user A, who is the creator of the deriving source recipe, as follows.

Partial reward for user A=Overall reward×(1−Third recipe independence degree)×Second relevance degree/(Second relevance degree+Third relevance degree) Formula(5)

That is, the processing unit 420 determines the partial reward for the user A based on the second relevance degree, with respect to the overall reward for the recipe 700c for “Mapo eggplant”. In the case of FIG. 10, the partial reward for the user A is 84.5% of the overall reward.

The partial reward for the user B is not paid; however, if it is paid, the processing unit 420 calculates the partial reward for the user B as follows.

Partial reward for user C=Overall reward×(1−Third recipe independence degree)×Second relevance degree/(Second relevance degree+Third relevance degree) Formula(6)

That is, the processing unit 420 determines the partial reward for the user C based on a sixth relevance degree, with respect to the overall reward for the recipe 700d for “Non-spicy Mapo tofu made in microwave”.

### (iv) Processing for Recipe 700d for “Non-Spicy Mapo Tofu Made in Microwave”

When the operation unit 154 of the user device 150d receives a corresponding operation by the user D, the processing unit 156 creates the recipe 700d for “Non-spicy Mapo tofu made in microwave”. The recipe 700d for “Non-spicy Mapo tofu made in microwave” is created in the same manner as the recipe 700a for “Mapo tofu”. The processing unit 156 generates a registration request for requesting registration of the recipe 700d for “Non-spicy Mapo tofu made in microwave”, and the communication unit 160 transmits the registration request.

The communication unit 410 of the management device 400 receives the registration request. Accordingly, the communication unit 410 obtains the recipe 700d for “Non-spicy Mapo tofu made in microwave”. The processing unit 420 then stores the recipe 700d for “Non-spicy Mapo tofu made in microwave” in the storage unit 430. As shown in FIG. 9A, the elements included in the ingredient information of the recipe 700d for “Non-spicy Mapo tofu made in microwave” are tofu, ground pork, garlic, ginger, and green onion. As shown in FIG. 9B, the elements included in the seasoning information of the recipe 700d for “Non-spicy Mapo tofu made in microwave” are miso, sesame oil, tianmian sauce (sweet flour sauce), potato starch, soy sauce, and chicken broth. As shown in FIG. 9C, the elements included in the order information of the recipe 700d for “Non-spicy Mapo tofu made in microwave” are mixing seasonings and microwave heating, arranged in this order. The description will now return to FIG. 5.

The processing unit 420 judges whether or not the recipe 700d for “Non-spicy Mapo tofu made in microwave” can be registered. The processing unit 420 checks the database shown in FIG. 10 and identifies the recipe 700a for “Mapo tofu”, the recipe 700b for “Non-spicy Mapo tofu”, and the recipe 700c for “Mapo eggplant” registered prior to the date and time of creation of the recipe 700d for “Non-spicy Mapo tofu made in microwave”. The processing unit 420 then calculates the relevance degree (hereinafter referred to as the “fourth relevance degree”) that indicates the degree to which the recipe 700d for “Non-spicy Mapo tofu made in microwave” contains a portion (hereinafter referred to as a “fourth related portion”) related to a recipe 700 already stored in the storage unit 430, such as the recipe 700a for “Mapo tofu”.

The calculation of the fourth relevance degree may be performed as follows, for example. The processing unit 420 identifies elements that are identical between the ingredient information of the recipe 700d for “Non-spicy Mapo tofu made in microwave” and the ingredient information of the recipe 700a for “Mapo tofu”. The processing unit 420 then calculates the ratio of the number of identical elements to the number of elements in the ingredient information of the recipe 700a for “Mapo tofu”, as the relevance degree in the ingredient information. According to FIG. 9A, since these five elements are all identical elements, the relevance degree in the ingredient information is “1”.

The processing unit 420 also identifies elements that are identical between the seasoning information of the recipe 700d for “Non-spicy Mapo tofu made in microwave” and the seasoning information of the recipe 700a for “Mapo tofu”. The processing unit 420 then calculates the ratio of the number of identical elements to the number of elements in the seasoning information of the recipe 700a for “Mapo tofu”, as the relevance degree in the seasoning information. According to FIG. 9B, since four of the six elements in the seasoning information of the recipe 700a for “Mapo tofu” are identical elements, the relevance degree in the seasoning information is “4/6”.

Further, the processing unit 420 identifies elements that are identical between the order information of the recipe 700d for “Non-spicy Mapo tofu made in microwave” and the order information of the recipe 700a for “Mapo tofu”. The processing unit 420 then calculates the ratio of the number of identical elements to the number of elements in the order information of the recipe 700a for “Mapo tofu”, as the relevance degree in the order information. According to FIG. 9C, since all these five elements are not identical elements, the relevance degree in the order information is “0”. Among the elements of the recipe 700d for “Non-spicy Mapo tofu made in microwave”, elements identical with elements in the recipe 700a for “Mapo tofu” correspond to the fourth related portion described previously. By substituting the aforementioned values into Formula (1), the processing unit 420 calculates the fourth relevance degree as “60%”.

Subsequently, the processing unit 420 calculates the relevance degree (hereinafter referred to as the “fifth relevance degree”) that indicates the degree to which the recipe 700d for “Non-spicy Mapo tofu made in microwave” contains a portion (hereinafter referred to as a “fifth related portion”) related to a recipe 700 already stored in the storage unit 430, such as the second recipe independent portion. As described previously, the second recipe independent portion indicates elements among the elements of the recipe 700b for “Non-spicy Mapo tofu” that are not identical with elements in the recipe 700a for “Mapo tofu”.

The calculation of the fifth relevance degree may be performed as follows, for example. The processing unit 420 identifies elements that are identical between the ingredient information of the recipe 700d for “Non-spicy Mapo tofu made in microwave” and the ingredient information of the second recipe independent portion. Since there is no ingredient information in the second recipe independent portion, the relevance degree in the ingredient information is “0”.

The processing unit 420 also identifies elements that are identical between the seasoning information of the recipe 700d for “Non-spicy Mapo tofu made in microwave” and the seasoning information of the second recipe independent portion. The processing unit 420 then calculates the ratio of the number of identical elements to the number of elements in the seasoning information of the second recipe independent portion, as the relevance degree in the seasoning information. According to FIG. 9B, since two of the two elements in the seasoning information of the second recipe independent portion are identical elements, the relevance degree in the seasoning information is “1”.

Further, the processing unit 420 identifies elements that are identical between the order information of the recipe 700d for “Non-spicy Mapo tofu made in microwave” and the order information of the second recipe independent portion. Since there is no order information in the second recipe independent portion, the relevance degree in the order information is “0”. Among the elements of the recipe 700d for “Non-spicy Mapo tofu made in microwave”, elements identical with elements in the second recipe independent portion correspond to the fifth related portion described previously. By substituting the aforementioned values into Formula (1), the processing unit 420 calculates the fifth relevance degree as “30%”.

Subsequently, the processing unit 420 calculates the relevance degree (hereinafter referred to as the “sixth relevance degree”) that indicates the degree to which the recipe 700d for “Non-spicy Mapo tofu made in microwave” contains a portion (hereinafter referred to as a “sixth related portion”) related to a recipe 700 already stored in the storage unit 430, such as the third recipe independent portion. As described previously, the third recipe independent portion indicates elements among the elements of the recipe 700c for “Mapo eggplant” that are not identical with elements in the recipe 700a for “Mapo tofu” or elements in the recipe 700b for “Non-spicy Mapo tofu”. The processing unit 420 performs the same processing as described previously; however, since there is no sixth related portion, the sixth relevance degree is “0%”.

Based on a related portion, such as the fourth through sixth related portions, the processing unit 420 calculates the independence degree (hereinafter referred to as the “fourth recipe independence degree”) that indicates the degree to which the recipe 700d for “Non-spicy Mapo tofu made in microwave” contains a portion (hereinafter referred to as a “fourth recipe independent portion”) independent of a recipe 700 already stored in the storage unit 430, such as the recipe 700a for “Mapo tofu” through the recipe 700c for “Mapo eggplant”. The fourth recipe independence degree is calculated, for example, by subtracting the fourth relevance degree, the fifth relevance degree, and the sixth relevance degree from 100%. In this example, the fourth recipe independence degree is “10%”.

When the fourth recipe independence degree is greater than or equal to a threshold, the processing unit 420 determines the registration of the recipe 700d for “Non-spicy Mapo tofu made in microwave”. Upon determining the registration of the recipe 700d for “Non-spicy Mapo tofu made in microwave”, the processing unit 420 leaves the information on the elements of the recipe 700d for “Non-spicy Mapo tofu made in microwave” stored in the storage unit 430 as it is. Also, the processing unit 420 adds information regarding the recipe 700d for “Non-spicy Mapo tofu made in microwave” to the database in the storage unit 430. On the other hand, when it is determined that the recipe 700d for “Non-spicy Mapo tofu made in microwave” will not be registered, the processing unit 420 deletes the information on the elements of the recipe 700d for “Non-spicy Mapo tofu made in microwave” stored in the storage unit 430.

In the database shown in FIG. 10, information identified by a recipe ID “0004” is stored as the information regarding the recipe 700d for “Non-spicy Mapo tofu made in microwave”. As the independence degree of the recipe 700d for “Non-spicy Mapo tofu made in microwave”, the fourth recipe independence degree of “10%” is input. Also, as the deriving source recipes of the recipe 700d for “Non-spicy Mapo tofu made in microwave”, the fourth relevance degree of the recipe ID “0001”, i.e., “60%”, is input, and the fifth relevance degree of the recipe ID “0002”, i.e., “30%”, is also input. The description will now return to FIG. 5.

When the overall reward for the recipe 700d for “Non-spicy Mapo tofu made in microwave” is obtained, the processing unit 420 acquires, from the database shown in FIG. 10, the fourth recipe independence degree of “10%”, the relevance degree of the recipe ID “0001”, i.e., the fourth relevance degree, of “60%”, and the relevance degree of the recipe ID “0002”, i.e., the fifth relevance degree, of “30%”. The partial reward for the user D, who is the creator of the recipe 700d for “Non-spicy Mapo tofu made in microwave”, is 10% of the overall reward, according to Formula (3). That is, the processing unit 420 determines the partial reward for the user D based on the fourth recipe independence degree, with respect to the overall reward for the recipe 700d for “Non-spicy Mapo tofu made in microwave”.

Also, when the overall reward for the recipe 700d for “Non-spicy Mapo tofu made in microwave” is obtained, the processing unit 420 calculates the partial reward for the user A, who is the creator of a deriving source recipe, as follows.

Partial reward for user A=Overall reward×(1−Fourth recipe independence degree)×Fourth relevance degree/(Fourth relevance degree+Fifth relevance degree+Sixth relevance degree) Formula(7)

That is, the processing unit 420 determines the partial reward for the user A based on the fourth relevance degree, with respect to the overall reward for the recipe 700d for “Non-spicy Mapo tofu made in microwave”. In the case of FIG. 10, the partial reward for the user A is 46.7% of the overall reward.

Also, the processing unit 420 calculates the partial reward for the user B, who is the creator of another deriving source recipe, as follows.

Partial reward for user B=Overall reward×(1−Fourth recipe independence degree)×Fifth relevance degree/(Fourth relevance degree+Fifth relevance degree+Sixth relevance degree) Formula(8)

That is, the processing unit 420 determines the partial reward for the user B based on the fifth relevance degree, with respect to the overall reward for the recipe 700d for “Non-spicy Mapo tofu made in microwave”. In the case of FIG. 10, the partial reward for the user A is 23.3% of the overall reward.

The partial reward for the user C is not paid; however, if it is paid, the processing unit 420 calculates the partial reward for the user C as follows.

Partial reward for user C=Overall reward×(1−Fourth recipe independence degree)×Sixth relevance degree/(Fourth relevance degree+Fifth relevance degree+Sixth relevance degree) Formula(9)

That is, the processing unit 420 determines the partial reward for the user C based on the sixth relevance degree, with respect to the overall reward for the recipe 700d for “Non-spicy Mapo tofu made in microwave”.

Thus, the partial reward for the creator of a recipe 700 as a deriving source is shown as follows.

Partial reward for a specific creator=Overall reward×(1−Independence degree)×Relevance degree of the creator/Z(Relevance degree) Formula(10)

This configuration may be implemented by a central processing unit (CPU) or memory of any given computer, a large scale integration (an LSI), or the like in terms of hardware, and by a memory-loaded program or the like in terms of software. In the present embodiment is shown a functional block configuration realized by cooperation thereof. Therefore, it will be understood by those skilled in the art that these functional blocks may be implemented in a variety of forms by hardware only or a combination of hardware and software.

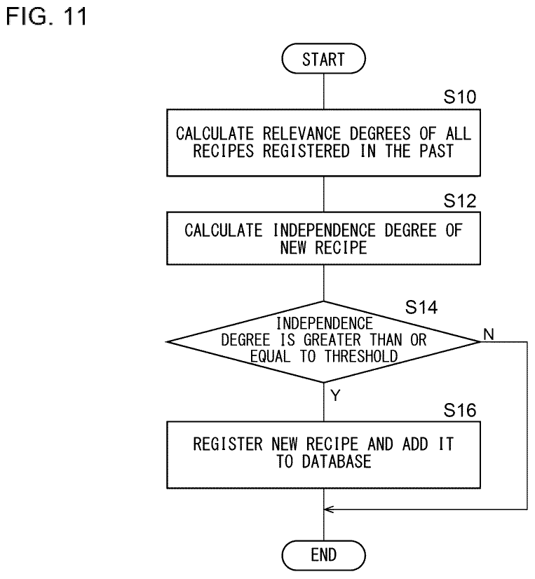

FIG. 11 is a flowchart that shows the procedure for registration of a new recipe 700 performed by the information processing system 1500. The processing unit 420 calculates the relevance degree of each of all recipes 700 registered in the past with respect to the new recipe 700 (S10). The processing unit 420 also calculates the independence degree of the new recipe 700 (S12). When the independence degree is greater than or equal to a threshold (Y at S14), the processing unit 420 registers the new recipe 700 and adds it to the database (S16). When the independence degree is less than the threshold (N at S14), the processing is terminated.

According to the present embodiment, the relevance degree that indicates the degree to which a new recipe contains a related portion related to a previous recipe is calculated, and, based on the related portion, the independence degree that indicates the degree to which the new recipe contains an independent portion independent of the previous recipe is also calculated, so that the relevance or independence between multiple recipes can be judged. Also, the relevance degrees that each indicate the degree to which a new recipe contains one of related portions related respectively to multiple previous recipes are calculated, and, based on the related portions, the independence degree that indicates the degree to which the new recipe contains an independent portion independent of the multiple previous recipes is also calculated, so that the relevance or independence between multiple recipes can be judged. Also, since the related portion between a new recipe and the independent portion of a previous recipe is identified, a situation can be prevented in which a specific portion of the new recipe is related to each of multiple previous recipes. Further, since a situation can be prevented in which a specific portion of a new recipe is related to each of multiple previous recipes, the relevance degrees and the independence degrees can be accurately calculated.

Also, since a new recipe is registered when the independence degree is greater than or equal to a threshold, registration of a new recipe that is almost identical to a previous recipe can be prevented. Also, with respect to the overall reward for a new recipe, the partial reward for the creator of a previous recipe is determined based on the relevance degree, so that the overall reward obtained for a derived recipe can be appropriately distributed also to the creator of a deriving source recipe. Further, with respect to the overall reward for a new recipe, the partial reward for the creator of the new recipe is determined based on the independence degree, so that an appropriate reward can be distributed to the creator of a derived recipe.

The outline of one embodiment of the present disclosure is as follows.

### Item 1

An information processing method, including:
acquiring a second recipe (700b) for a dish created after a first recipe (700a) for a dish;
calculating a first relevance degree that indicates a degree to which the second recipe (700b) contains a first related portion related to the first recipe (700a); and
calculating, based on the first related portion, a second recipe independence degree that indicates a degree to which the second recipe (700b) contains a second recipe independent portion independent of the first recipe (700a).

### Item 2

The information processing method according to claim 1, further including:
acquiring a third recipe (700c) for a dish created after the second recipe (700b);
calculating a second relevance degree that indicates a degree to which the third recipe (700c) contains a second related portion related to the first recipe (700a);
calculating a third relevance degree that indicates a degree to which the third recipe (700c) contains a third related portion related to the second recipe independent portion; and
calculating, based on the second related portion and the third related portion, a third recipe independence degree that indicates a degree to which the third recipe (700c) contains a third recipe independent portion independent of the first recipe (700a) and the second recipe (700b).

### Item 3

The information processing method according to claim 2, further including:
acquiring a fourth recipe (700d) for a dish created after the third recipe (700c);
calculating a fourth relevance degree that indicates a degree to which the fourth recipe (700d) contains a fourth related portion related to the first recipe (700a);
calculating a fifth relevance degree that indicates a degree to which the fourth recipe (700d) contains a fifth related portion related to the second recipe independent portion;
calculating a sixth relevance degree that indicates a degree to which the fourth recipe (700d) contains a sixth related portion related to the third recipe independent portion; and
calculating, based on the fourth related portion, the fifth related portion, and the sixth related portion, a fourth recipe independence degree that indicates a degree to which the fourth recipe (700d) contains a fourth recipe independent portion independent of the first recipe (700a), the second recipe (700b), and the third recipe (700c).

### Item 4

The information processing method according to Item 1, further including registering the second recipe (700b) when the second recipe independence degree is greater than or equal to a threshold.

### Item 5

The information processing method according to Item 4, further including:
determining a partial reward for the creator of the first recipe (700a) based on the first relevance degree, with respect to an overall reward for the second recipe (700b); and
determining a partial reward for the creator of the second recipe (700b) based on the second recipe independence degree, with respect to the overall reward for the second recipe (700b).

### Item 6

The information processing method according to Item 2, further including registering the third recipe (700c) when the third recipe independence degree is greater than or equal to a threshold.

### Item 7

The information processing method according to Item 6, further including:
determining a partial reward for the creator of the first recipe (700a) based on the second relevance degree, with respect to an overall reward for the third recipe (700c);
determining a partial reward for the creator of the second recipe (700b) based on the third relevance degree, with respect to the overall reward for the third recipe (700c); and
determining a partial reward for the creator of the third recipe (700c) based on the third recipe independence degree, with respect to the overall reward for the third recipe (700c).

### Item 8

The information processing method according to Item 3, further including registering the fourth recipe (700d) when the fourth recipe independence degree is greater than or equal to a threshold.

### Item 9

The information processing method according to Item 8, further including:
determining a partial reward for the creator of the first recipe (700a) based on the fourth relevance degree, with respect to an overall reward for the fourth recipe (700d);
determining a partial reward for the creator of the second recipe (700b) based on the fifth relevance degree, with respect to the overall reward for the fourth recipe (700d);
determining a partial reward for the creator of the third recipe (700c) based on the sixth relevance degree, with respect to the overall reward for the fourth recipe (700d); and
determining a partial reward for the creator of the fourth recipe (700d) based on the fourth recipe independence degree, with respect to the overall reward for the fourth recipe (700d).

### Item 10

An information processing device (400), including:
an acquirer (410) that acquires a second recipe (700b) for a dish created after a first recipe (700a) for a dish; and
a processing unit (420) that calculates a first relevance degree that indicates a degree to which the second recipe (700b) contains a first related portion related to the first recipe (700a),
wherein the processing unit (420) calculates, based on the first related portion, a second recipe independence degree that indicates a degree to which the second recipe (700b) contains a second recipe independent portion independent of the first recipe (700a).

### Item 11

A program causing a computer to implement:
acquiring a second recipe (700b) for a dish created after a first recipe (700a) for a dish;
calculating a first relevance degree that indicates a degree to which the second recipe (700b) contains a first related portion related to the first recipe (700a); and
calculating, based on the first related portion, a second recipe independence degree that indicates a degree to which the second recipe (700b) contains a second recipe independent portion independent of the first recipe (700a).

The present disclosure has been described with reference to an embodiment. The embodiment is intended to be illustrative only, and it will be obvious to those skilled in the art that various modifications to a combination of constituting elements or processes in the embodiment could be developed and that such modifications also fall within the scope of the present disclosure.

The processing unit 420 in the present embodiment predetermines the allocation rate of the ingredient information, the allocation rate of the seasoning information, and the allocation rate of the order information. However, the application is not limited thereto, and the processing unit 420 may predetermine the allocation rate of the ingredient information, the allocation rate of the seasoning information, the allocation rate of the order information, and an allocation rate of information with a low relevance degree. The information with a low relevance degree indicates the lowest relevance degree among the relevance degree in the ingredient information, the relevance degree in the seasoning information, and the relevance degree in the order information. If the relevance degree in the seasoning information is the lowest, the information with a low relevance degree corresponds to the relevance degree in the seasoning information. For example, the allocation rate of the ingredient information of “25%”, the allocation rate of the seasoning information of “25%”, the allocation rate of the order information of “25%”, and the allocation rate of the information with a low relevance degree of “25%” may be determined. This modification increases the independence degree of a new recipe.

The processing unit 420 in the present embodiment predetermines the allocation rate of each piece of information. However, the application is not limited thereto, and the processing unit 420 may increase the allocation rate of information selected by the user, for example. This modification increases the independence degree of a new recipe.

The processing unit 420 in the present embodiment distributes the overall reward to the creators of recipes 700 that each have the relevance degree greater than “0%”. However, the application is not limited thereto, and the processing unit 420 may distribute the overall reward only to the creators of the top N recipes 700 with greater relevance degrees, among the recipes 700 that each have the relevance degree greater than “0%”, for example. Also, the processing unit 420 may set the relevance degrees less than or equal to a certain value K (K is a value greater than or equal to 1) to 0. This modification can reduce the number of creators of recipes 700 to whom distributions are provided.

In the present embodiment, the reward receipt of a recipe 700 that has been initially registered and is not related to other recipes 700, such as the recipe 700a for “Mapo tofu”, is set to Yes. However, the application is not limited thereto, and the reward receipt of such a recipe 700 may be set to No. In that case, the partial reward for the creator of such a recipe 700 may be distributed to the creator of a recipe 700 derived from such a recipe 700. This modification can increase the partial reward distributed to the creator of a derived recipe 700.

When multiple recipes 700 are created, the processing unit 420 in the present embodiment stores information regarding the multiple recipes 700 in a database as shown in FIG. 10. Based on the database, the processing unit 420 may create a diagram showing the relationships among the multiple recipes 700 as shown in FIG. 8 and display it on a user device 150. The processing unit 420 may also display the database on the user device 150. With the display, a related recipe 700, the relevance degree, and the user who created it are shown, for example. According to this modification, the users can explore the roots of local specialty and home cooking. Also, the users can enjoy exploring the roots of their own dishes. Further, the creator of an original recipe can know what kind of dish has been derived from the original recipe or what kind of dish the original recipe has developed into.

What is claimed is:

1. An information processing method, comprising:
acquiring a second recipe for a dish created after a first recipe for a dish;
calculating a first relevance degree that indicates a degree to which the second recipe contains a first related portion related to the first recipe; and
calculating, based on the first related portion, a second recipe independence degree that indicates a degree to which the second recipe contains a second recipe independent portion independent of the first recipe.

2. The information processing method according to claim 1, further comprising:
acquiring a third recipe for a dish created after the second recipe;
calculating a second relevance degree that indicates a degree to which the third recipe contains a second related portion related to the first recipe;
calculating a third relevance degree that indicates a degree to which the third recipe contains a third related portion related to the second recipe independent portion; and
calculating, based on the second related portion and the third related portion, a third recipe independence degree that indicates a degree to which the third recipe contains a third recipe independent portion independent of the first recipe and the second recipe.

3. The information processing method according to claim 2, further comprising:
acquiring a fourth recipe for a dish created after the third recipe;
calculating a fourth relevance degree that indicates a degree to which the fourth recipe contains a fourth related portion related to the first recipe;
calculating a fifth relevance degree that indicates a degree to which the fourth recipe contains a fifth related portion related to the second recipe independent portion;
calculating a sixth relevance degree that indicates a degree to which the fourth recipe contains a sixth related portion related to the third recipe independent portion; and
calculating, based on the fourth related portion, the fifth related portion, and the sixth related portion, a fourth recipe independence degree that indicates a degree to which the fourth recipe contains a fourth recipe independent portion independent of the first recipe, the second recipe, and the third recipe.

4. The information processing method according to claim 1, further comprising registering the second recipe when the second recipe independence degree is greater than or equal to a threshold.

5. The information processing method according to claim 4, further comprising:
determining a partial reward for the creator of the first recipe based on the first relevance degree, with respect to an overall reward for the second recipe; and
determining a partial reward for the creator of the second recipe based on the second recipe independence degree, with respect to the overall reward for the second recipe.

6. The information processing method according to claim 2, further comprising registering the third recipe when the third recipe independence degree is greater than or equal to a threshold.

7. The information processing method according to claim 6, further comprising:
determining a partial reward for the creator of the first recipe based on the second relevance degree, with respect to an overall reward for the third recipe;
determining a partial reward for the creator of the second recipe based on the third relevance degree, with respect to the overall reward for the third recipe; and
determining a partial reward for the creator of the third recipe based on the third recipe independence degree, with respect to the overall reward for the third recipe.

8. The information processing method according to claim 3, further comprising registering the fourth recipe when the fourth recipe independence degree is greater than or equal to a threshold.

9. The information processing method according to claim 8, further comprising:
determining a partial reward for the creator of the first recipe based on the fourth relevance degree, with respect to an overall reward for the fourth recipe;
determining a partial reward for the creator of the second recipe based on the fifth relevance degree, with respect to the overall reward for the fourth recipe;
determining a partial reward for the creator of the third recipe based on the sixth relevance degree, with respect to the overall reward for the fourth recipe; and
determining a partial reward for the creator of the fourth recipe based on the fourth recipe independence degree, with respect to the overall reward for the fourth recipe.

10. An information processing device, comprising:
an acquirer that acquires a second recipe for a dish created after a first recipe for a dish; and
a processing unit that calculates a first relevance degree that indicates a degree to which the second recipe contains a first related portion related to the first recipe,
wherein the processing unit calculates, based on the first related portion, a second recipe independence degree that indicates a degree to which the second recipe contains a second recipe independent portion independent of the first recipe.

11. A program causing a computer to implement:
acquiring a second recipe for a dish created after a first recipe for a dish;
calculating a first relevance degree that indicates a degree to which the second recipe contains a first related portion related to the first recipe; and
calculating, based on the first related portion, a second recipe independence degree that indicates a degree to which the second recipe contains a second recipe independent portion independent of the first recipe.
